(19) United States
(12) Patent Application Publication
(10) Pub. No.: US 2003/0194929 A1
(43) Pub. Date: Oct. 16, 2003

(54) Awning fabric and method for producing the same

(76) Inventor: Gu Ui Mun, Daegu (KR)

Correspondence Address: Jonathan Y. Kang, Esq., Lee & Hong P.C., 11th Floor, 221 N. Figueroa Street, Los Angeles, CA, 90012-2601, US

(21) Appl. No.: 10/397,471

(22) Filed: Mar. 26, 2003

(30) Foreign Application Priority Data
Apr. 15, 2002 (KR) 2002-0020302

(51) Int. Cl. B32B 5/22; B32B 5/18; D03D 15/00; D03D 25/00

(52) U.S. Cl. 442/76; 442/181

(57) ABSTRACT

The awning fabric according to the invention, which is formed by weaving, at a high density, high-bulky and texturized polyester filament yarns and then by treating uniformly the inner and outer surfaces of the resulting fabric with a coating solution of polytetrafluoroethylene, is low-priced and is superior to any other existing awning fabrics of various materials and structures in the respect of the sunlight and color fastness, the weather and water resistance and other basic physical properties, whereby it is, as a special fabric, adapted for yacht covers, parasols, signboard textiles and the like.

### FIELD OF THE INVENTION

The present invention relates to an awning fabric and a method for producing the same and more particularly to a fabric excellent in sunlight-fastness and color-fastness and a method for manufacturing such a fabric.

Awning fabrics have long been used in the United States and many European countries as outdoor awning screens or curtains and raw cloths for parasols, for shutting off the light and in consideration of the surrounding atmosphere. Recently in Korea also, such awning curtains are put up on the external facades of entertaining-business buildings such as high-class restaurants or coffee shops specially in big cities, not just for the purpose of shutting off the sun rays into the interior of buildings and preventing the rain or snow, but also for the purpose of imparting an advertising effect to customers through an intense impression of the enterprise by giving a visual effect of differentiation from other enterprises based on a variety of unique colors and patterns.

Because the awning fabrics are chiefly installed outside the buildings, the fabrics should withstand the discoloration or decolorization by the sunlight at least for five years, tough as well as weather resistance, and in addition, should have a definite hardness, light-weight and firmness for unartifical bending of a desired degree.

Even though thick textures made of a tough natural hemp fabric were put to use at first, then the weight was high, various colors were hardly attained, and further were apt to be discolored or decolorized by the sunlight, lacking in weather resistance and durability, whereby the hemp fibers were replaced by synthetic fibers.

Furthermore, these days the awning screens or awning curtains made of the awning fabric function rather as trade-marks signifying the services or qualities of the commodities offered by stores, differently from the past time when they were used merely to block the sunlight as described above. Therefore, a good attention is being paid to the quality of awning products itself as well, with the result that the acrylic fibers mainly made into staple yarn, out of many synthetic fibers, are widely used as the awning fabric mainly due to the easy dyeability for the purpose of creating a high-class image.

The fabric made of acrylic fibers are light in comparison to natural hemp fabrics and nevertheless are excellent in the strength and non-monotonous in the appearance and can produce an image of luxury due to their pleasant touch and draping property and allow dyeing in various colors unlike most of other synthetic fibers.

However, the awning fabrics made of acrylic fiber have the limit to their wide-spread application because of the high price, above all.

### SUMMARY OF THE INVENTION

The present invention was intended, under the recognition of the above-described problems with the known awning fabrics, to develope an awning fabric capable of producing an atmosphere similar to that of acrylic fiber products while being manufactured at a reduced cost, the awning fabric being excellent not only in the strengths including the tensile strength but also in the sunlight fastness as well as color fastness in comparison to the acrylic fiber.

Thus, there was developed, according to the invention, an awning fabric based on the polyester filament yarns, the fabric hitherto avoided as an awning fabric, which fabric exceeds the acrylic fiber in the sunlight fastness, color fastness, weather resistance and water repellence and is also superior to the acrylic fiber in the basic physical properties such as the various strengths including the tensile strength, hardness and draping property, thanks to specially processed polyester filament yarns intended for the fabric product with a unique atmosphere.

### DETAILED DESCRIPTION OF THE INVENTION

The inventive awning fabric, which withstands the discoloration or decolorization by the sunlight due to the balanced dyeing and the fastness of color and sunlight and is excellent in the weather resistance and durability so as to be adapted for the covers for yachts, sunscreens and the like to prevent both the sunlight and the rain or snow, is formed by weaving, at a high density, high-bulky and texturized polyester filament yarns and then by treating uniformly the inner and outer surfaces of the resulting fabric with a coating solution of polytetrafluoroethylene.

Particularly, the method for manufacturing an awning fabric according to the invention includes the processes of: texturizing polyester filament yarns; sizing said texturized polyester filament yarns and then weaving the same; and treating the resulting woven fabric with a coating solution containing polytetrafluoroethylene.

When the coating solution further includes a melamine resin in the treating process as described above, the woven fabric can have an improved touch and have an excellent physical properties as required for an awning fabric owing to an synergic effect with polytetrafluoroethylene.

Further, the awning fabric, as usual, can be yarn-dyed or fabric-dyed, or particularly can be colored in the state of starting resin solution at the time of spinning filaments through extrusion by a dope dyeing(solution dyeing), so that the inner and outer surfaces of the fabric may be uniformly dyed and may have an excellent durability including the weather resistance and the fastness of the light and color.

The polyester filament yarns for the awning fabric according to the invention, consisting of high-molecular compounds from copolymerization of multivalent basic acids with multivalent alcohols, includes usual polyethyleneterephthalate from dimethylterephthalate and ethylene glycol under the trade name of Tetoron, Terylene or Dacron; Kodel (trade name, Eastman Chemical, U.S.A), a copolymerized product from dimethylterephthalate and 1,4-cyclohexanedimethanol; and Vycron (trade name, North American Rayon, U.S.A), a copolymerized product in the form of mixed ester from dimethylterephthalate/methylisophthalate and ethylene glycol.

According to an aspect of the invention, the polyester filament yarns are subjected to the air-texturizing process in which the filament yarns are exposed to compressed air to cause friction of the smooth surface area with the air and water, so that naps and fluffs or feathers in the form of coils, curls, crimps, loops and the like are generated on the surface of filament yarns.

That is, a number of strands of the polyester filament yarns wound on respective creels are simultaneously unwound to pass through a nozzle, being put together, and subsequently exposed to a high pressure air, wherein the surface of the combined strands is damaged, scratched and cracked to produce a number of naps, fluffs or feathers, so that bulky property is enhanced and appearance like spun yarns results.

It is desirable to supply a predetermined amount of water regularly, because the generation of static electricity can be prevented and the surface of filaments rendered somewhat wet can have an increased friction effect, when the water is supplied through a nozzle on the surface of polyester filament yarns in the process described above.

The awning fabrics according to the invention are woven very densely and are provided, as themselves, with a certain degree of water resistance. Moreover, the water repellence and awning property are further improved because the woven fabrics were treated with a coating solution based on polytetrafluoroethylene. Although the amount of polytetrafluoroethylene varies dependent on the amount of the fabrics treated, preferably it is added to the water at the rate of 3-9% by weight. Under the above lower limit, the water repellence and awning property are poor, while the treating cost becomes unduly high when the amount exceeds the upper limit. In addition, when the melamine resin is added at the rate of 5-12% by weight to the coating solution together with catalyst, the hardness can be regulated more closely. When the amount is less than the lower limit, the desired hardness is not attained. When the amount exceeds the upper limit, however, the surface of the woven product would be too hard. While the primary purpose of adding the melamine resin is to make the touch of the manufactured fabrics harder, the resin additionally cooperates with polytetrafluoroethylene described above to contribute to the optimum function and effect as an awning fabric in the respect of water repellence, light fastness, weather resistance, resistance to heat and chemicals, and gloss.

As the method for coloring the awning textile and the dyes or pigments used therefor, ordinary methods and dyes may be equally applied, as no special requirements are imposed. However, the dyes with an excellent resistance to the sunlight and high temperature and the color-fastness and the corresponding methods may be preferably employed. In other words, the dyeing is conducted either according to a yarn-dyeing method night after texturizing the polyester filament yarns or according to a fabric-dyeing method after the texturizing (texture-process) and subsequent weaving process of the polyester filament yarns during the manufacturing process in conventional manner, depending on the situations.

Furthermore, for the awning fabric according to the invention there can be employed a dope dyeing(solution dyeing) method in which the dye or pigment is added to the extruder when the original resin solution of ester-based polymer is extruded for spinning, so that the colorant is uniformly mixed with the filaments for homogenized coloring. In this case, the inner and outer parts of polyester filament yarns are uniformly dyed at an equal distribution overall and therefore the color tone fastness and weather resistance become excellent when the awning fabrics thereafter are put to use for tents or the like. Accordingly, this last dyeing method wold most preferable.

### DETAILED DESCRIPTION OF THE INVENTION

The invention is described below along Examples for better understanding of the characteristics of the awning fabric and the method for manufacturing the same according to the invention. However, it is to be understood that the Examples are only to help understand the invention and therefore any modification and alterations would be possible by the men skilled in the art within the spirit of the invention and the appended claims.

### EXAMPLE 1

5 strands of 100D (D: denier) polyester filament yarn (manufactured by Dong Yang Nylon Co., Korea) were unwound simultaneously from respective creels and introduced to a nozzle of an air-texturizing apparatus. The introduced yarns were joined into a single strand while progressing forward and in that course of progressing, the smooth surface of filaments got wet a little and was brought into frictional contact with the compressed air, by the action of a high-pressure air and water suppled from one side of the nozzle, whereby many fine curls, loops and the like were produced from wounds around the surfaces of filament strands, resulting in many fine naps and fluffs or feathers over the all surfaces. As the result, the single yarn now exceeding 540D had accordingly a considerably increased apparent volume so as to resemble the appearance of a spun yarn giving a voluminous rich feeling.

After sizing the textured yarns so produced, 2 strands were used as a warp and a weft to form a very densely woven fabric. The formed cloth was dyed as usual, water-washed, dipped in a coating solution consisting of a mixture of Teflon(trade name) and water at the ratio of 0.06:1 and dried under tentering and finally wound.

The results of the tests of fabrics so formed, which were conducted under a constant condition and which included physical properties such as weather resistance, tensile strength, water repellence and elasticity, and the fastness of dyeing as well as sunlight, showed such an excellency as to exceed the standard for the awning fabric by far.

### EXAMPLE 2

The same procedures as in the above Example 1 were conducted, except that the melamine resin solution with the melamine content of 35% was added to the same coating solution as in Example 1, at the ratio 1:0.08 of the treating solution to the melamine solution.

The results of tests conducted just as in Example 1 revealed that the awning fabric in this example excelled the awning product from the previous example with regard to the sunlight fastness and the water repellence. Thus, it may be concluded that the further treatment with a melamine resin is more preferable.

### EXAMPLE 3

An awning fabric was manufactured in the same manner as in Example 1, except that at the time of extruding the polyester melt for spinning, the pigment was added to the spinning base solution contained in the hopper of the extruder and mixed well before spinning the filaments.

The results of the tests for this awning fabric conducted in the same procedure as in Example 1 revealed that the dyeing balance and the color fastness as well as sunlight fastness were superior somewhat to the fabric in the first example while other physical properties remained almost the same.

As described above, according to the invention, awning fabrics with an appearance excellent in touch and sense to produce a luxurious atmosphere can be manufactured at a much lower price than conventional other fabrics. Further, the weight, tensile and other strengths, and hardness as required of an awning fabric are appropriate and the water resistance, particularly water repellence is so excellent as to allow the hot air or humidity under an awning tent to pass upward and nevertheless be able to shut off the sunlight and the rain or snow. The weather resistance and excellent durability make this fabric most appropriate for the awning textile for covers or roofs in yachts, outdoor awning tents, curtains, parasols etc.

Further, the awning fabric according to the invention can be provided in a variety of colors in line with the latest trend to attract the attention of consumers mainly due to the brilliant and balanced dyeability, which, together with color fastness and light fastness, makes this fabric optimum, specially as the basic textile for outdoor signboards.

What is claimed is:

1. An awning fabric for the sunlight blocking and for the water resistance and water repellence, the inner and outer surfaces of the fabric having been treated with a coating solution of polytetrafluoroethylene uniformly after weaving, at a high density, high-bulky and texturized polyester filament yarns.

2. The awning fabric as defined in claim 1, wherein said coating solution further includes a melamine resin solution.

3. The awning fabric as defined in claim 1, wherein said polyester filament yarns are woven after dyeing, or dyed after being woven into a grey fabric, or the raw resin solution for the polyester filament yarns is colored with dyes or pigments before spinning at the extrusion and spinning step.

4. The awning fabric as defined in claim 2, wherein said polyester filament yarns are woven after dyeing, or dyed after being woven into a grey fabric, or the raw resin solution for the polyester filament yarns is colored with dyes or pigments before spinning at the extrusion and spinning step.

5. A method for manufacturing an awning fabric, including the processes of: texturizing polyester filament yarns via spinning; sizing said texturized polyester filament yarns and then weaving the same; and treating the resulting woven fabric with a coating solution of polytetrafluoroethylene.

6. The method as defined in claim 4, wherein said polyester filament yarns are dyed after the texturizing, or dyed as a grey fabric after the weaving process, or a raw solution of ester-based polymers is colored with dyes or pigments before spinning at the extrusion and spinning step.

7. The method as defined in claim 4, wherein said coating solution further includes a melamine resin solution.
